(19) United States
(12) Patent Application Publication
(10) Pub. No.: US 2006/0214323 A1
(43) Pub. Date: Sep. 28, 2006

(54) Low linting, high absorbency, high strength wipes composed of micro and nanofibers

(76) Inventors: Walter Chappas JR., Raleigh, NC (US); Walter Chappas SR., Raleigh, NC (US)

Correspondence Address: HUTCHISON LAW GROUP PLLC, PO BOX 31686, RALEIGH, NC, 27612, US

(21) Appl. No.: 11/386,308

(22) Filed: Mar. 22, 2006

Related U.S. Application Data
(60) Provisional application No. 60/664,347, filed on Mar. 23, 2005.

(51) Int. Cl. B29C 37/02

(52) U.S. Cl. 264/138

(57) ABSTRACT

A wipe having at least one nanofiber layer including an commingled configuration providing low linting, low pilling and high liquid absorbency and method of making same is described. A nanofiber layer is configured from a commingled nanofiber precursor layer of micro- or macrofibers that is subjected to splittable, friable or chemical methods to provide the nanofiber layer. Multiple layer wipes including a commingled nanofiber layer web produced from a commingled nanofiber precursor layer and micro- or macrofiber layer are also described.

### CROSS-REFERENCE TO RELATED APPLICATIONS

This application claims the benefit of U.S. Provisional Application No. 60/664,347, filed Mar. 23, 2005, and is incorporated herein by reference in its entirety.

### TECHNICAL FIELD

The subject matter disclosed herein relates generally to fabrics used as wipes comprising nanodiameter fibers having antipilling, low linting and high abrasion resistance properties. The present subject matter relates to methods for reducing the pilling tendency and improving abrasion resistance of a pillable highly absorbent wipe fabric using a fiber commingling process and wipes made therefrom.

### BACKGROUND

Many wipes are composed of woven and knitted fabrics. These fabrics have a tendency to “pill” or “lint”. Pill or lint are small bunches or balls of interlaced fluff caused by small bundles of entangled fibers clinging to the fabric surface by one or more surface fibrils that have separated from the bulk.

Several solutions have previously been disclosed alleging to prevent such generation of pills in fibers and fabrics. For example, U.S. Pat. No. 3,975,486 to Sekiguchi et al. is directed to a process for producing an antipilling acrylic fiber wherein the steps of coagulation, stretching and relaxing heat treatment are conducted under particular conditions. U.S. Pat. No. 6,051,034 to Caldwell is directed to a method for reducing pilling of cellulosic towels wherein a composition comprising an acidic agent, and optionally a fabric softener, is applied to a pillable cellulosic towel, preferably to the face yarns of the towel. The towel is then heated for a time and under conditions sufficient to effect a controlled degradation of the cellulosic fibers, thereby reducing pilling.

While these prior art antipilling techniques have included various methods of reducing the pilling tendency of a fabric using chemical or other process modifications, many wipes, including cleanroom wipes, are generally made from continuous filaments made into a knitted or nonwoven product. Some products include a sandwich of meltblown fibers (2-10 microns typically) between two layers of knitted or spunbonded products. This composite structure is held together loosely and the edges are sometimes sealed to prevent the fragmentation and escape of the broken fibers from the middle layer. These products generally do not, however, have high abrasion resistance and may have limited absorbency properties.

Hydroentanglement or “spun lacing” is a process used for mechanically commingling a web of loose fibers to form fabrics directly from fibers. This class of fabric typically belongs to the nonwovens family of engineered fabrics. In conventional hydroentangling processes, webs of nonwoven fibers are treated with high pressure fluid jets while supported on apertured patterning screens. The underlying mechanism in hydroentanglement is the subjecting of the fibers to a non-uniform pressure field created by successive manifolds of fine, closely spaced, high-velocity water jets. The impact of the water jets with the fibers, while they are in contact with their neighboring fibers, displaces' and rotates the fibers with respect to their neighbors and physically entangles these fibers with the neighboring fibers. During these relative displacements, some of the fibers twist around others and/or interlock with the neighboring fibers to form a strong structure likely due to fiber-to-fiber frictional forces. The final outcome is usually a compressed and uniform fabric composed of entangled fibers that is generally characterized by relatively high strength, flexibility, and conformability. For example, U.S. Pat. No. 4,695,500 to Dyer et al. is directed to a loosely constructed knit or woven fabric that is dimensionally stabilized by causing staple length textile fibers to be entangled about the intersections of the yarns comprising the fabric.

While these prior art hydroentanglement finishing processes have been directed to improving dimensional stability and physical properties such as edge fray and drape and abrasion resistance, there remains a need to better reduce the lint tendency and develop a wipe that will prevent or eliminate fiber fragments (pills or lint) during use.

Nanofiber materials may be included in woven and non-woven fabrics to be used for cleaning and polishing purposes. Such structures are disclosed, for example, in Anderson et al., U.S. Pat. No. 4,100,324; Meitner, U.S. Pat. No. 4,307,143; Anderson et al., U.S. Pat. No. 5,651,862 and Torobin, U.S. Pat. No. 6,269,513. These nanofiber containing structures rely on a technology in which the nanofibers are incorporated and distributed throughout a non-woven or woven matrix and combined with other fiber in the fiber mass. Discrete nanofiber layers are found in or on such structures as disclosed in Grafe, published U.S. Pat. Appl. No. 20040092185, published May 13, 2004. The disclosed nanofiber inside the nonwoven layers allegedly improves cleaning properties of the pad, wipe or composite material.

However, like conventional woven and non-woven wipes, even those wipes containing nanofiber dispersed in the bulk material may not have adequate lint and abrasion or wet-strength properties. These wipes may also fail in use because they lack sufficient mechanical strength. In addition, the larger diameter fiber layer of these nanofiber-dispersed configurations may result in linting, pilling or slow liquid uptake not acceptable to end-users. This may be especially important for wipes designed for cleanroom use, where the level of particulates generated by wipes must be kept very low or to undetectable levels. Accordingly, a substantial need exists for wipe configurations that are low linting, low pilling and highly absorbent whilst having good mechanical strength, especially for wipes adapted to function in cleanroom environments.

### SUMMARY

A composition and method for producing low lint, high absorbency, and high strength wipes are disclosed. The composition includes nanodiameter absorbent fibers.

In one embodiment, a method of forming a low linting, low pilling, high absorbency wipe is provided comprising the steps of:

providing at least one layer comprising nanofiber precursor fibers;

commingling the layer comprising nanofiber precursor fibers; and

converting at least 20% of the layer comprising nanofiber precursor fibers to nanofibers of a diameter less than about 900 nanometers by splitting, fracturing or chemical processing.

In yet another embodiment, a wipe is provided comprising at least one layer including nanofibers with diameters less than about 900 nanometers made by a method comprising the steps of:

providing at least one layer comprising nanofiber precursor fibers;

commingling the nanofiber precursor fibers; and converting at least about 20% by weight of the layer comprising nanofiber precursor fibers to nanofibers of a diameter less than about 900 nanometers by splitting, fracturing or chemical processing.

In another embodiment, a wipe is disclosed having a surface and an interior, comprising at least one knitted, woven, or nonwoven layer comprising nanofibers, the nanofibers having diameters less than about 900 nanometers, wherein the wipe has a mean pore diameter of at least 25 microns.

In yet another embodiment, a wipe is provided comprising a single knitted, woven or nonwoven layer comprising two or more pluralities of fiber diameter distributions wherein at least one plurality of fiber diameter distributions has an mean fiber diameter of less than about 900 nanometers, wherein the wipe has a mean pore diameter of at least 25 microns.

### BRIEF DESCRIPTION OF THE DRAWINGS

FIG. 1 is a schematic drawing of an apparatus for the fiber commingling process in accordance with the present subject matter;

FIG. 2a-b depicts 3 layer composite structure embodiments suitable for subsequent hydroentangling;

FIG. 3 depicts a two-sided, two layer structure embodiment suitable for subsequent hydroentangling;

FIG. 4 depicts a single layer structure embodiment suitable for subsequent hydroentangling;

FIGS. 5 a-d depict graphically data regarding the rate (change of grams of water per gram of wipe as a function of time) and water absorption (grams of water absorbed per gram of wipe as a function of time) for hydroentangled, needle punched and point bonded wipes.

### DETAILED DESCRIPTION

The subject matter disclosed herein relates to methods for reducing the linting tendency, improving absorbency and increasing strength of wipes through the use of nanofiber precursor fibers and a fiber commingling process.

As used herein, the term “mean pore diameter” refers to the diameter of a pore (or space) formed between commingled fibers in a layer. The mean pore diameter is determined using image analysis or by dimensional measurement of a sufficient number of visible pores (>10% of total) and calculation of the mean value.

As used herein, the term “basis weight” refers to mass per unit area, with grams per square meter (gsm) as the preferred unit as measured according to ASTM D 756.

As used herein the term “layer” includes a web or part of a web or a fabric that is produced in a separate fiber lay down, forming, woven or knitting step.

Previously known methods of producing nanofiber containing articles include spinning a larger diameter bicomponent fiber in an islands-in-the-sea, segmented pie, or other configuration, wherein the fiber is further processed after the fiber has solidified so as to produce nanofibers. The larger diameter multicomponent fiber is split or fractured with high energy impaction or the “sea” is chemically dissolved so that nanofibers result. For example, see U.S. Pat. No. 5,290,626 by Nishio et al., and U.S. Pat. No. 5,935,883, by Pike et al., which describe the islands-in-the-sea and segmented pie nanofiber formation methods, respectively. The then formed nanofibers may be included in, or layered on, conventional knitted, woven or non-woven fiber webs.

In contrast, the methods described herein provide for nanofiber wipes that are produced from a nanofiber precursor layer. The precursor web may be constructed as an integral part of a multilayer wipe or may be the only layer of the wipe. The nanofiber precursor layer is subjected to a conversion step in which the nanofiber precursor layer is converted to a layer containing nanofibers. The conversion step includes splitting, fracturing, using high energy impaction, such as hydrotreatment, or chemically processing. The conversion step may result in complete conversion of the precursor fibers to nanofibers or may partially convert the precursor fibers. Preferably, at least 20% of the precursor fibers are converted to nanofibers. The nanofiber precursor layer is preferably commingled prior to the conversion of the nanofiber precursor layer, either intermingled with another layer, or intramingled with the fibers of the precursor layer. Alternatively, a single component nanofiber precursor fiber layer may be used, which is subsequently split or fractured using high energy impaction, such as hydrotreatment, or chemically processed to provide nanofibers. The resultant nanofiber comprising layer may again be commingled, either inter- or intramingled as described above. In this manner, single and multiple layer wipe construction is available, and the method herein described may provide for wipes with low linting, low pilling and high liquid absorbency properties while maintaining good wet strength during use.

The wipe includes one or more layers having a significant number of nanofibers with the nanofibers having mean diameters of less than about 900 nanometers. A significant number is defined as at least about 20%. The significant number of fibers can be at least about 30%, at least about 50%, or more than 75% of the total number of fibers in the layer. The wipe may have about 100% of the fibers having a diameter of less than about 900 nanometers. The fiber diameters of the wipe may be measured using a scanning electron microscope at a magnification as needed for visual analysis and accurate measurement. The wipe may be of a thickness of about 1 mil to about 500 mil or more depending on the particular application, and generally will contain an interior bounded by a pair of opposing surfaces. The various layers of the wipe, for example, the single and multiple layers including the nanofiber precursor layer may comprise the interior of the wipe.

Fibers for the nanofiber precursor layer may include continuous microfibers or macrofibers that may be produced from direct spinning or through a bi-component spinning process. The use of continuously spun microfibers and macrofibers produced from any one of several production techniques, including segmented pie and islands in the sea configurations are within the scope of the present embodiments.

Commingling methods include hydrotreatment, for example, such as hydroentanglement, which may be accomplished by methods known to those of ordinary skill in the art including hydroentanglement on a belt drum and belt/drum combination using high pressure water jets. The water pressure jets from one or more manifolds may be between 10 and 1000 bars. Hydroentangling may also swirl the fibers and entangle them into a dense structure. Although needle-punching can accomplish some of this function, the efficiencies and quality of the product may not match the hydroentangling process, but nonetheless; may be used. These commingling processes may enhance the strength and abrasion resistance while reducing pilling of the wipe.

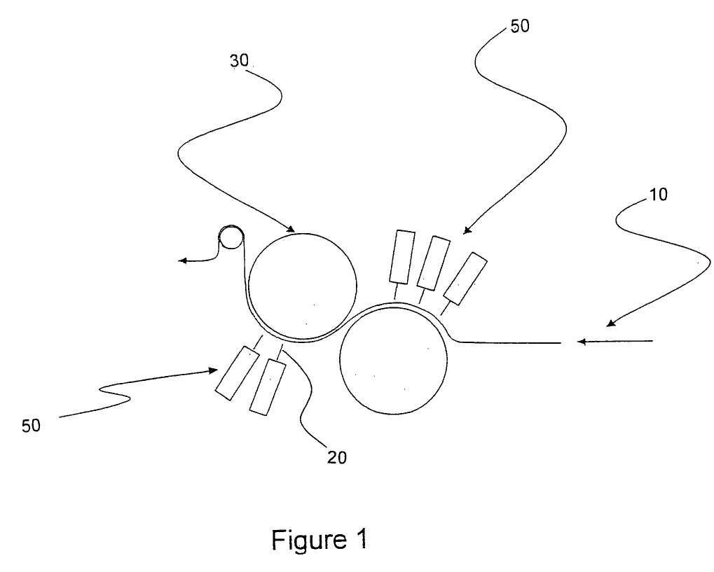

Various embodiments of wipes disclosed herein are illustrated by way of the following examples and Figures. For example, a fiber commingling process scheme for fibers by hydroentanglement is depicted in FIG. 1, wherein single or multiple layers of material (10) are fed through drum assembly (30) whilst manifolds (50) provide high energy water jet streams (20) directed to and impinging upon the material (10).

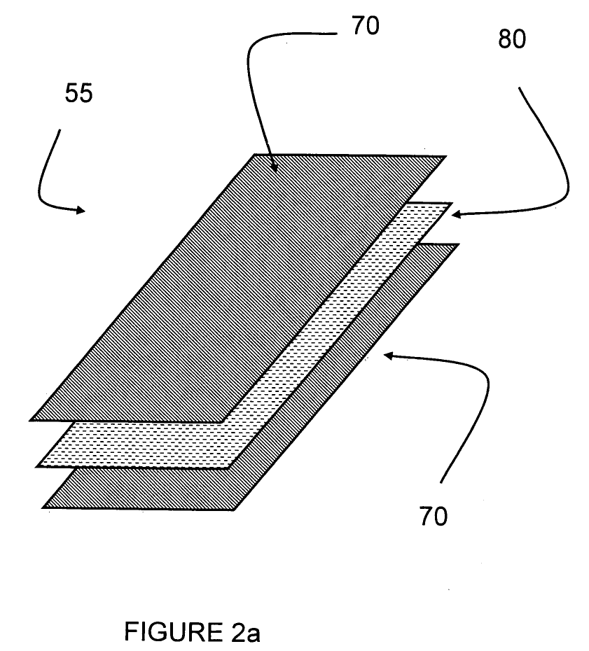

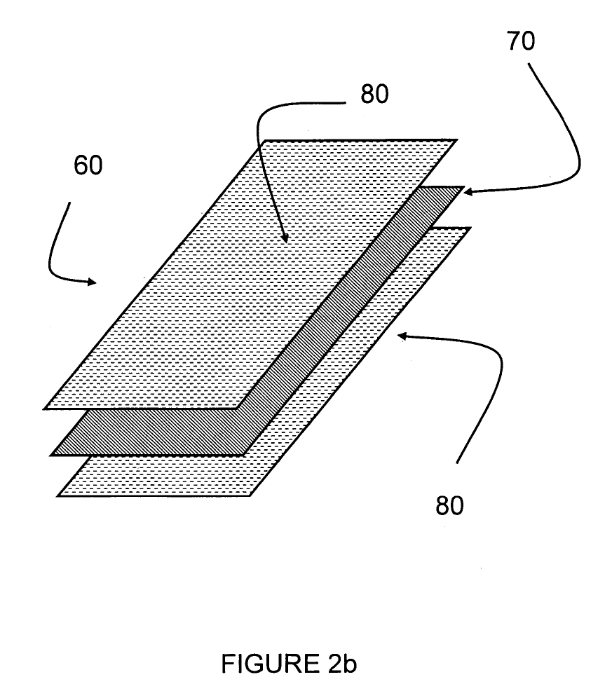

In one embodiment, the wipes may initially comprise a sandwich structure composed of two knitted, woven or nonwoven layers that encapsulate a nanofiber precursor layer, wherein the nanofiber precursor fibers may be splittable, or islands in the sea bicomponent fibers comprised of spunbond filaments or continuous filaments. For example, a sandwich construct (55) suitable for the process of commingling as previously described is shown in FIG. 2a, wherein the outside layers (70) comprising woven, non-woven or knitted materials sandwich nanofiber precursor layer (80). Nanofiber precursor layer (80) includes micro- or macrofiber material of continuous filament or staple construction. Such structure may then be processed, for example, using the equipment and methods as described above and depicted in FIG. 1. Alternatively, a sandwich construct (60) suitable for the process of commingling as previously described is shown in FIG. 2b, wherein the outside layers (80) comprising nanofiber precursor layer woven, sandwich non-woven or knitted materials (70).

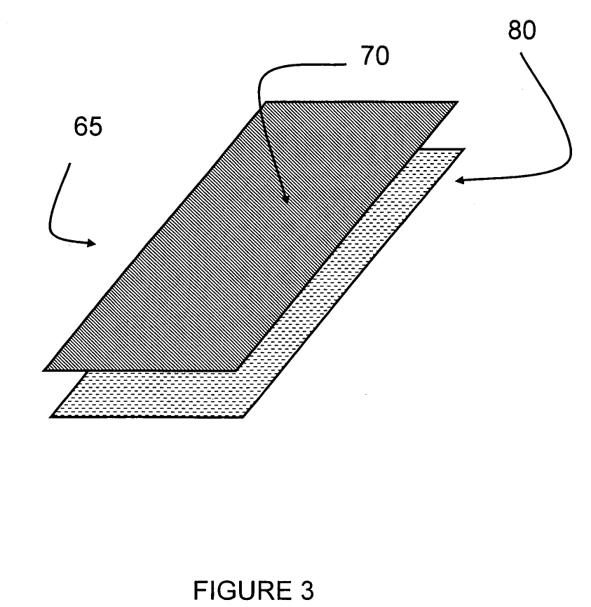

In another embodiment, the wipes may initially comprise a two layer structure composed of a knitted, woven or nonwoven layer attached to a nanofiber precursor layer, wherein the nanofiber precursor layer is as described above. For example, a two layer construct (65) suitable for the process of commingling as previously described is shown in FIG. 3, wherein an outside layer (70) comprising woven, non-woven or knitted materials is positioned adjacent nanofiber precursor layer (80). Such structure may then be processed, for example, using the equipment and methods as described above and depicted in FIG. 1.

In another embodiment, the wipes may initially comprise a sandwich structure composed of two nanofiber precursor layers that encapsulate a knitted, woven or nonwoven layer, wherein the nanofiber precursor layer is as described above. Such structure may then be processed, for example, using the equipment and methods as described above and depicted in FIG. 1.

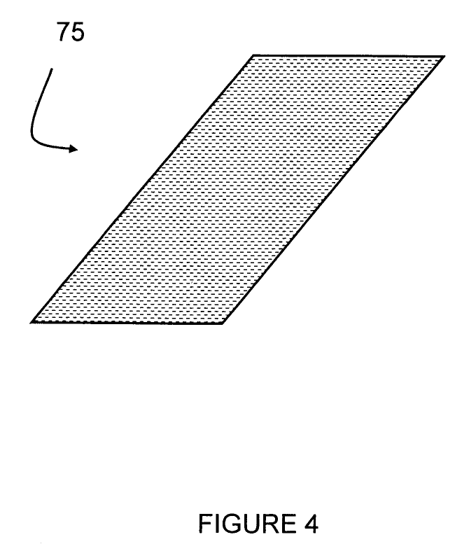

In another embodiment, the wipes may also initially comprise a single-layer structure composed of nanofiber precursor layer as described above. For example, a single layer construct (75) suitable for the process of commingling as previously described is shown in FIG. 4, wherein the single layer includes an absorbent nanofiber precursor layer (80). Such structure may then be processed, for example, using the equipment and methods as described above and depicted in FIG. 1.

The multilayered and sandwiched structures described above may be bonded together simultaneously, prior to or subsequent to the commingling process. Bonding may be carried out using ultrasonic bonding, thermal bonding or thermal calendar bonding. Bonding may be carried out such that about 15% to about 30% of the surface areas of the structures are bonded together.

Subsequent to incorporation and formation into a wipe, each nanofiber precursor layer may be converted, in whole or in part, into smaller diameter nanofibers through splitting or fracturing, for example, by high energy hydrotreatment (as in FIG. 1), splitting, fracturing or by chemically removing one of the components in the fiber. In these processes, nanofibers are produced that are long, continuous fibers or staple fibers with typical mean diameters of about 1 to about 900 nanometers. The resultant fiber diameter obtained by the methods herein disclosed may be measured using a Scanning Electronic Microscope (SEM) and image analysis software. Any magnification may be used such that the fibers are suitably enlarged for reasonably accurate measurements.

A layer that results from the conversion of the nanofiber precursor layer may comprise nanofibers having a mean diameter of about 100 nanometers to about 900 nanometers, preferably about 200 to about 800 nanometers. The basis weight of a nanofiber layer converted from the precursor layer may be from about 10 gsm to about 600 gsm and may be from about 40 gsm to about 600 gsm.

The nanofiber precursor fibers of the wipe configuration may be continuous fibers or staple fibers. Nanofiber precursor fibers may comprise natural and/or synthetic polymers including, but not limited to polyolefins, polyesters, polyamides, biodegradable polymers, polyurethanes, polystyrenes, and combinations thereof. Natural fibers such as cellulose may be preferred for comfort and/or appearance. Other fibers may be used in combination with the nanofiber precursor layer of the wipe.

It may be desirable to produce a single layer nanofiber precursor layer with varying fiber diameters. Alternatively, it can be desired to produce a nanofiber precursor with multiple layers of nanofiber precursor fibers with each precursor layer having different fiber compositions or different fiber diameters. For example, smaller fiber diameters having a significant number of fibers having a diameter of less than 900 nanometers and larger diameter fibers, for example, fibers from the melt blowing range (typically 3 to 5 microns) to the spunbond (typically around 15 microns) or any range of fiber diameters above about 1 micron, may be used. Another example includes producing multiple layers of nanofiber precursor fibers with each layer having a distinct mean fiber diameter. The same polymer may be used to produce different nanofiber precursor fiber diameters, or different polymers may be used to produce the same nanofiber precursor fiber diameters.

An example of a segmented pie geometry bi-component nanofiber precursor useful in the methods herein described includes commercially available Evolon, sold by Freudenberg & Co., Weinheim an der Bergstrasse, Germany. Fibers comprising the island in the sea configuration are also commercially available. With regard to the island of the sea fibers, the conversion to nanofiber process relies on solvents to dissolve away the “sea”, leaving reduced diameter individual fibers (the “islands”) behind. In a similar manner, sheath-core configurations of nanofiber precursor fibers are also amenable to chemical conversion to nanofibers and are thus included in the scope of bi-component fibers useful for preparing the wipe.

After the nanofiber precursor layer of the wipe has been converted to a nanofiber containing layer, the wipe may be subjected to additional processing, including but not limited to, hydroentanglement, needle punching, calendaring, bonding, chemical treatment or other finishing methods.

Thus, the final wipes may take form in many configurations to allow designing of the wipe for particular applications. For example, a two layer construct comprising a nano/spunbond (n/s) layering or a three layer construct comprising a nano/spunbond/nano (n/s/n) layering may maximize the amount of the nanofibers on the surface of the wipe while providing additional structural integrity to the interior of the wipe. Alternatively, a spunbond/nano/spunbond (s/n/s) structure may offer a more rugged exterior with specific absorption properties from the nanofibers in its interior. More complex composites for other special functionality may also be envisaged.

The mean pore diameter of the final wipes produced by the methods herein disclosed are preferably greater than about 20 microns, preferably greater than about 30 microns, and preferably more than about 50 microns. It is believed that the method herein described allows for larger pore sizing due to the distribution of large and small diameter fibers created during the conversion of the nanofiber precursor layer. Such pore sizes may increase liquid uptake and retention properties of the wipes. Basis weights for the final wipes produced by the methods herein disclosed may range from about 50 gsm to about 200 gsm.

For many wipe applications, the most economical option may be wipes constructed entirely from nonwovens (spunbond with and without calendaring and point bonding). However, any fabrication technique for any of the aforementioned single or multilayer structures, including weaves, knits, nonwovens or wovens may be used.

By way of the methods herein described, the surfaces and/or edges of the wipe may not lint or pill. Although not to be held by any theory, it is believed that the use of a high energy commingling process, such as for example, a hydroentanglement process, significantly improves the physical and mechanical properties of fabrics and wipes made therefrom.

For example, it is believed that the hydroentangling process creates intimate commingling of the fibers, both inward (toward the center of the matrix) as well as outward (toward the surface). This produces an unexpected but very important advantage for wipes. As the smaller nanofibers of the interior are driven toward the surface they commingle with a surface sheet comprised of larger fibers, enhancing the liquid and dust uptake of the wipe and aiding in the capillary attraction of liquids to the center of the wipe.

Thus, the commingling processes may create wipes with surfaces where nanofibers constitute 15% to 75% of the surface fibers. The commingling processes may create an interior where nanofibers constitute 5% to 75% of the interior. The commingling processes may also create a structure that will absorb 200% (by weight) or more of solvent or aqueous liquid. The amount of nanofiber on the surface and within the interior of the wipe may be determined by microscopy methods, for example, SEM.

It is believed that the commingling processes result in the removal of surface yarn fibrils by entangling them into the body of the fabric thereby improving the fabric strength while making the surface more smooth and lint free. It is believed that the improved absorbency of the wipes results from the formation of a plurality of capillaries or pores within the wipe from the entanglement of the nanofibers with the rest of the macro/micro fiber structure providing capillary fluid transport. Thus, even hydrophobic polymers, such as polypropylene, when used in the methods herein described, can be used effectively as a wipe material with liquid absorbency properties.

A significant number of fibers in the wipe may have a fiber diameter of less than about 900 nanometer and more preferably from about 100 nanometers to about 900 nanometers. The fibers in the wipe may have a diameter of less than 800 nanometers and from about 200 to about 800 nanometers. The preferred diameters depend upon the desired end-use of the wipe. For process and product benefits, it may be desirable in some applications to have a plurality of fibers in the wipe, with one plurality having a diameter of less than about 900 nanometers and another plurality of fibers having a diameter of greater than about one micron within the same layer of the wipe or among adjacent layers of the wipe. The combination of larger diameter fibers and nanofibers among layers or within layers may trap and immobilize the nanofibers. This may help to reduce or eliminate clumping or roping of the nanofibers and may prevent the nanofibers or other components of the wipe from being carried off by stray air currents. This feature is desirable for cleanroom applications.

The methods herein described may provide wipes wherein the presence of lint may be reduced on one or more surfaces to a level that would meet 100 or better cleanroom requirements. Cleanrooms are classified in terms of the number and sizes of particles suspended in its atmosphere. A particle is defined as a solid or liquid object between 0.001 and 1000 microns in size. Table 1 shows the various cleanroom classes and their corresponding statistically allowable number of particles per cubic foot of air, as defined by Federal Standards 209E. To illustrate, in a Class 100 cleanroom, a cubic foot of air may only have 100 particles whose size is 0.5 micron.

TABLE 1
Cleanroom Classes:

| Class Name | 0.1 micron | 0.2 micron | 0.3 micron | 0.5 micron | 5 micron |
|---|---|---|---|---|---|
| 1 | 35 | 7.5 | 3 | 1 | N/A |
| 10 | 350 | 75 | 30 | 10 | N/A |
| 100 | N/A | 750 | 300 | 100 | N/A |
| 1000 | N/A | N/A | N/A | 1000 | 7 |
| 10000 | N/A | N/A | N/A | 10000 | 70 |
| 100000 | N/A | N/A | N/A | 100000 | 700 |

### EXAMPLES

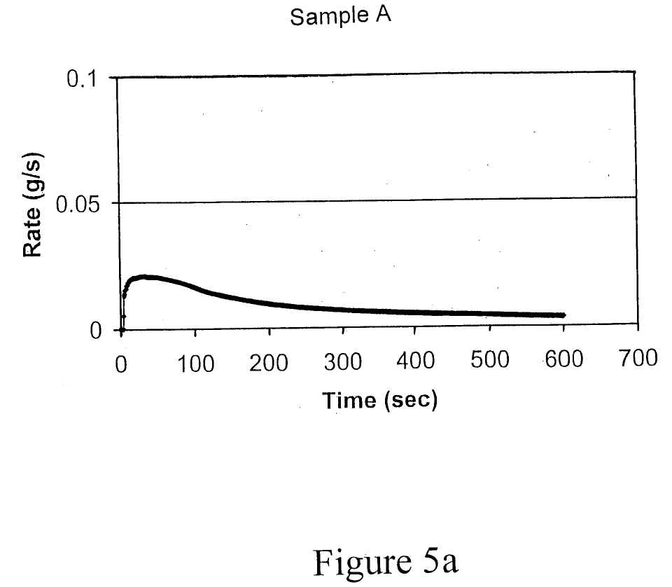

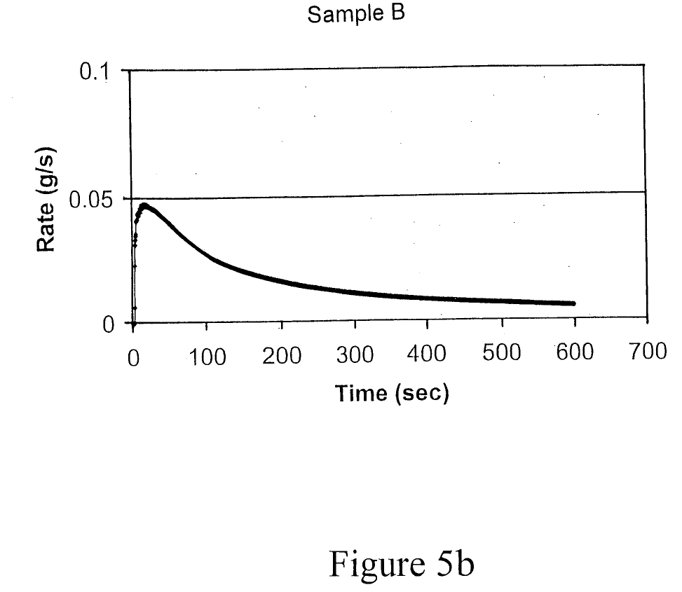

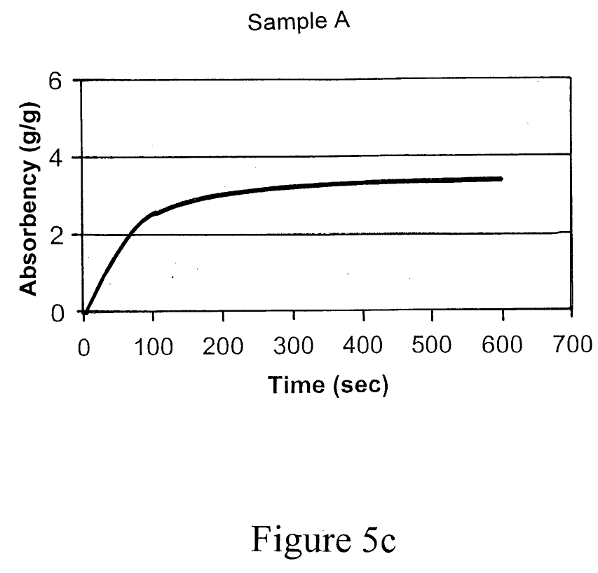

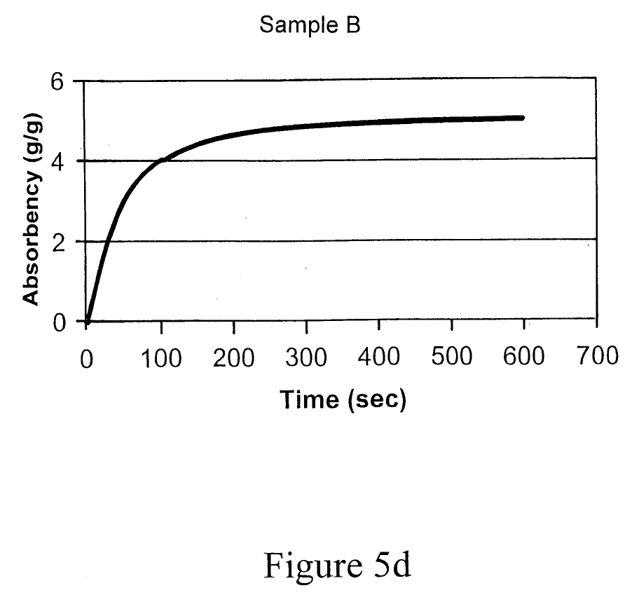

Two wipes were made in accordance with the methods herein disclosed. Sample A was constructed as a single layer wipe including a nylon nanofiber precursor layer converted to a nanofiber containing wipe by hydroentanglement as disclosed herein. Sample B was constructed as the same single layer wipe as Sample A, hydroentangled, and further calendared and point bonded. FIGS. 5 a-b show water absorption rate (grams of water absorbed per gram of wipe as a function of time) for Samples A and B, respectively. FIGS. 5 b-c show water absorption (grams of water absorbed per gram of wipe) for Samples A and B, respectively. As indicated by the graphs, both wipes provide acceptable water absorption profiles whilst, as might be expected, the absence of post calendaring and point bonding reduces the total absorption and rate of absorption.

The wipe herein disclosed may be used to clean virtually any soiled or contaminated surfaces. Such surfaces may include surfaces in the home including metal, plastic, wood, glass or other surface. Such surfaces may include surfaces found in industry including process equipment, instrumentation, computer equipment, communications equipment, etc. Such surfaces may include surfaces common in the hospital environment such as instrumentation, beds, gurneys, operating theater environments, laboratory environments, etc. Other important surfaces include surfaces found in cleanroom environments or surfaces that may be contaminated by chemical or biological agents, or radioactive agents. Other surfaces include parts of the human body. The wipes may also be used for medical, hygienic or cosmetic purposes. Such applications include baby wipes, medical wipes; cosmetic wipes, facial wipes or flushable materials.

Due to the high surface area of the nanofibers, the webs may be used as absorbent materials for wipes or cores of feminine care product pads, diapers, training pants, or adult incontinence products. The high surface area also enhances cleaning and may be used in hygiene cleaning wipes. The wipe designs herein disclosed may provide enhanced distribution of fluids and/or retention. Additionally, the wipes for absorbent uses may be made with added particulates or absorbents or natural fibers, or certain layers of the wipes may have different properties for providing increased absorbance.

The wipes may be pre-moistened or combined with a liquid material and packaged in a container that maintains the wipe in a pre-moistened condition. The container may comprise a single use envelope or a multiuse pop-up dispenser or related containers. The liquid materials may include alcohols, cleaners, disinfecting solutions, decontaminating solutions, coating solutions, wax coating solutions, cosmetic solutions, human deodorant solutions, facial moisturizers, facial cleaners, make-up removing solutions and other materials. The liquid material combined with the wipe may be an aqueous based or solvent based material. Such solvents include alcohol, light petroleum distillate, ketones, ethers and other typically volatile solvent materials. Such liquids can also contain some small proportion of an aqueous material that can be either dissolved or suspended in the solvent solution.

While particular embodiments of the present invention have been illustrated and described, various other changes and modifications can be made without departing from the spirit and scope of the invention. It is therefore intended to cover in the appended claims all such changes and modifications that are within the scope of this invention.

All documents cited are incorporated herein by reference.

What is claimed is:

1. A method of forming a low linting, low pilling, high absorbency wipe comprising the steps of:
providing at least one nanofiber precursor fiber layer;
commingling the nanofiber precursor fibers of the at least one nanofiber precursor fiber layer; and
converting at least 20% of the nanofiber precursor fiber to nanofibers of a diameter less than 900 nanometers by a splitting, fracturing or chemical process.

2. The method of claim 1, wherein the nanofiber precursor fibers are continuous fibers or staple fibers, and the nanofiber precursor fiber layer is selected from the group consisting of knitted, woven and nonwovens.

3. The method of claim 1, wherein the commingling comprises hydroentangling or needle punching.

4. The method of claim 1, further comprising commingling the wipe after converting the nanofiber precursor layer to nanofibers.

5. The method of claim 1, further comprising commingling at least one knitted, woven or nonwoven layer with the nanofiber precursor fiber layer before converting the nanofiber precursor layer to nanofibers.

6. The method of claim 1, wherein the commingling comprises hydroentanglement or needle punching.

7. The method of claim 5, wherein the at least one knitted, woven or nonwoven layer and the nanofiber precursor fiber layer are ultrasonically, thermally, or thermally calendar bonded, thermal bonding, and thermal calendar bonding bonded prior to commingling.

8. The method of claim 5, wherein the at least one knitted, woven or nonwoven layer and the nanofiber precursor fiber layer are ultrasonically, thermally, or thermally calendar bonded, thermal bonding, and thermal calendar bonding bonded after commingling.

9. The method of claim 5, wherein the at least one knitted, woven or nonwoven layer comprises a cellulosic fiber.

10. The method of claim 1, wherein the wipe has a mean pore diameter of at least 25 microns.

11. The method of claim 1, wherein the wipe has a basis weight of from about 50 gsm to about 200 gsm.

12. The method of claim 1, wherein the presence of lint is reduced on the wipe to a level that meets at least class 100 cleanroom requirements.

13. A wipe comprising:
at least one layer including nanofibers with diameters less than 900 nanometers made by a method comprising the steps of:
providing at least one nanofiber precursor fiber layer;
commingling the nanofiber precursor fibers of the at least one nanofiber precursor fiber layer; and
converting at least about 20% by weight of the nanofiber precursor fibers to nanofibers of a diameter less than 900 nanometers by a splitting, fracturing or chemical process.

14. The wipe of claim 13, wherein the nanofiber precursor fibers are continuous fibers or staple fibers, and the nanofiber precursor fiber layer is selected from the group consisting of knitted, woven and nonwovens.

15. The wipe of claim 13, wherein the wipe has a mean pore diameter of at least 25 microns.

16. The wipe of claim 13, further comprising hydroentangling or needle punching the wipe after converting the nanofiber precursor layer to nanofibers.

17. The wipe of claim 13, further comprising:
providing at least one layer comprising at least one knitted, woven or nonwoven layer; and
commingling the nanofiber precursor fibers with the least one layer comprising at least one knitted, woven or nonwoven layer before converting the nanofiber precursor layer to nanofibers.

18. The wipe of claim 17, further comprising a commingling step after converting the at least one nanofiber precursor layer to nanofibers.

19. The wipe of claim 13, wherein the nanofibers have a diameter of about 200 to about 800 nanometers.

20. The wipe of claim 13, wherein the wipe exhibits an absorbency of greater than 200%.

21. The wipe of claim 13, wherein the converted nanofiber precursor fiber has a mechanical strength greater than 1 gram/denier.

22. The wipe of claim 13, wherein the presence of lint is reduced on the wipe to a level that meets at least class 100 cleanroom requirements.

23. A wipe having a surface and an interior, comprising:
at least one knitted, woven, or nonwoven layer comprising nanofibers, the nanofibers having diameters less than about 900 nanometers, wherein the wipe has a mean pore diameter of at least 25 microns.

24. The wipe of claim 23, further comprising at least one knitted, woven, or nonwoven layer adjacent the at least one knitted, woven, or nonwoven layer comprising nanofibers.

25. The wipe of claim 23, wherein the nanofibers comprises at least 20% by weight of the wipe and wherein the nanofibers constitute about 15% to about 75% of the wipe surface and about 5% to about 75% of the wipe interior.

26. The wipe of claim 23, wherein the at least one knitted, woven or nonwoven layer comprising nanofibers comprises two or more pluralities of fiber diameter distributions wherein at least one plurality has an mean fiber diameter of less than about 900 nanometers.

27. The wipe of claim 23, wherein the at least one knitted, woven or nonwoven layer comprising nanofibers has a mechanical strength greater than 1 gram/denier.

28. The wipe of claim 23, wherein the nanofiber layer is selected from the group consisting of polyolefins, polyesters, polyamides, biodegradable polymers, polyurethanes, polystyrenes, and combinations thereof.

29. The wipe of claim 24, wherein the at least one knitted, woven or nonwoven layer and the at least one knitted, woven or nonwoven layer comprising nanofibers are commingled by hydroentangling or needle punching.

30. The wipe of claim 24, wherein the at least one knitted, woven or nonwoven layer comprises a cellulosic fiber.

31. The wipe of claim 24, wherein the at least one knitted, woven or nonwoven layer and the at least one knitted, woven or nonwoven layer comprising nanofiber precursors are ultrasonically, thermally, or thermally calendar bonded.

32. The wipe of claim 23, wherein the wipe has a basis weight of from about 50 gsm to about 200 gsm.

33. The wipe of claim 23, wherein the at least one knitted, woven or nonwoven layer comprising nanofibers has a basis weight of from about 10 gsm to about 600 gsm.

34. The wipe of claim 23, wherein the nanofibers have a diameter of about 200 to about 800 nanometers.

35. The wipe of claim 23, wherein the presence of lint is reduced on the wipe to a level that meets at least class 100 cleanroom requirements.

36. A wipe comprising:
a single knitted, woven or nonwoven layer comprising two or more pluralities of fiber diameter distributions wherein at least one plurality of fiber diameter distributions has an mean fiber diameter of less than about 900 nanometers, and
wherein the wipe has a mean pore diameter of at least 25 microns.

37. The wipe of claim 36, wherein the wipe has a basis weight of from about 50 to about 200 gsm.

38. The wipe of claim 36, wherein the nanofiber is selected from the group consisting of polyolefins, polyesters, polyamides, biodegradable polymers, polyurethanes, polystyrenes, and combinations thereof.

39. The wipe of claim 36, wherein the plurality of fiber diameter distributions of mean fiber diameter of less than about 900 nanometers has a basis weight of from about 10 gsm to about 600 gsm.

40. The wipe of claim 36, wherein the plurality of fiber diameter distributions of mean fiber diameter of less than about 900 nanometers has a basis weight of from about 40 gsm to about 600 gsm.

41. The wipe of claim 36, wherein the presence of lint is reduced on the wipe to a level that meets at least class 100 cleanroom requirements.
